(19) United States
(12) Patent Application Publication
(10) Pub. No.: US 2016/0242002 A1
(43) Pub. Date: Aug. 18, 2016

(54) SOCIAL NETWORK SYSTEM AND METHOD OF USE

(71) Applicant: Rochel Albert, North Miami Beach, FL (US)

(72) Inventor: Rochel Albert, North Miami Beach, FL (US)

(21) Appl. No.: 15/042,227

(22) Filed: Feb. 12, 2016

Related U.S. Application Data
(60) Provisional application No. 62/115,288, filed on Feb. 12, 2015.

(51) Int. Cl. H04W 4/02; H04W 4/12; H04W 12/02

(52) U.S. Cl. CPC H04W 4/023; H04W 12/02; H04W 4/12

(57) ABSTRACT

The present invention provides a method and system whereby a visual indicator is viewed that identifies a person as a member of a particular network and whereby private communications with that person is provided based on their physical location.

### INDEX TO RELATED APPLICATIONS

This application is a non-provisional of and claims benefit to U.S. Provisional Patent Application Ser. No. 62/115,288 filed Feb. 12, 2015 the disclosure of which is incorporated herein by reference its entirety.

### BACKGROUND OF THE INVENTION

While there are person-to-person identifying systems and methods, there exists in all of them a similar deficiency. That is, there is no way to identify a registered person without launching a person-to-person system. In the popular Tinder system, a person can launch an app and see who is nearby. The present invention provides a significant improvement in that the visual identifier is viewed and a person instantly knows that the wearer/user of the identifier is on the desired person-to-person system and/or network.

### SUMMARY OF THE INVENTION

The application realizes the function of a social network, though the use of geographic tagging and user profiles. The intention is to provide connections between people who are physically located near to each other, and have cohesive interests registered with the service.

The application will comprise of three parts—a client, a server, and an identifier.

Although the examples are for an iPhone embodiment, the invention includes a system and method utilizing any mobile computing devices.

In one embodiment, the client will run on iPhone devices from Apple, and handsets based on the Android operating system, with care taken to ensure future expandability to other platforms. The user experience will be the same across the two platforms, in terms of functionality and appearance, only differing where necessary for system integration (such as the display of event notifications).

The server (in one embodiment referred to as the QBand Network Service) will be developed to run on all Web Services, providing maximum scalability, but the use of standard database and query techniques will provide flexibility in moving the server to a different cloud as required.

The prototype application will be self-signed, limiting distribution to registered mobile computing devices open to external installations.

Prior to installation the user (or agent) will be required to fill out an on-line registration from which gathers information including any one or combination of information but not limited to:
Name
Trade
Religion
Sports interests
Philanthropic preferences
Educational level
Musical taste
Artistic influences
Environmental inclination
Relationship status
Ideal relationship status
Preferred language

For the prototype application this information will be entered though a web-based form. That information will be stored in a cloud-hosted database, keyed to a generated membership number. That database has fields for location information and activity archiving, though these are automatically populated during application use.

That information will be stored in a cloud-hosted database, keyed to a generated membership number. That database has fields for location information and activity archiving, though these are automatically populated during application use.

That information will be stored in a cloud-hosted database, keyed to a generated membership number. That database has fields for Location information and activity archiving, though these are automatically populated during application use.

The user may run the application at any time, and is immediately presented with a list of QBand members within a prescribed perimeter. This information is gathered from the central database, based on the user's current location. This feature may be turned off to search for users with similar search criteria.

The list of users is presented in descending order of distance—the nearest user at the top of the list. Precise member locations are not passed to the device, only the distance from the querying member.

Only members that have a prescribed coherence to the querying member will appear on the list. That coherence can be based on any of the gathered information, but for the purpose of the prototype members will have to match at least two of the gathered information fields to be eligible for listing.

The user can tap to a listed member to get a photograph of that person, and from that screen they can also send a notification to that member's handset.

The user can tap to a listed member to get a photograph of that person, and from that screen they can also send a notification to that member's handset.

The notification mechanism is platform dependent, but tapping on a notification will display a picture of the member wishing to communicate and the ability to call or text that person with a single tap.

The QBand wrist band, or pin badge, device is not, within this prototype, envisioned as having a network connection to the handset, but the addition of Bluetooth or NFC would add considerable functionality if required.

A Near Frequency Communication (NFC) chip in the band would enable the user to trigger the application by tapping the band (or pin) against their own handset. Tapping the band (or pin) against a handset belonging to another member could automatically transfer contact information (sourced from the central database) into the address book of the user.

NFC chips cost less than $1 and require no battery, so could be cheaply integrated. Apple is not currently permitting external developers to use NFC with iPhone devices, but as the hardware is already integrated such permission is expected to arrive with the Apple iWatch, until that time additional functionality will only work on Android-based devices.

The addition of Bluetooth LE would permit the user to press a button on the QBand to trigger the application, and allow the band to vibrate when receiving notifications, but would require a battery with the attendant charging issues.

The prototype application will not provide the envisioned QBoards or QAlert functionality, which are intended to provide community notice boards and pro active notifications respectively. This functionality will be reserved for a later incarnation of the project.

In one embodiment, the present invention is a method for providing communications said method comprising the steps of:
registering a client with a database; providing said client with at least one identifier constructed and arranged to be worn by said client in a manner by which set identifier is readily visible by an observer; providing said client a system mobile computing application operatively associated with a mobile computing device, whereby said mobile computing device is constructed and arranged to provide location information through said mobile computing application;
viewing said identifier by an authorized person with access to said database;
accessing a communications application on a mobile computing device by said authorized person; receiving location information of identifiers presents in a pre-defined distance from said mobile computing device of set authorized person; and transmitting a private message from set authorized person to said client.

In one embodiment, the identifier is visual indicia worn by said client.

In one embodiment, the identifier is associated with at least one of a wristband, a pin, a keychain, a charm, and combinations thereof. The positioning of the identifier as any of these is not meant to include any identifier, being a symbol, logo, sign, and the like that is visible and viewable by another when worn by the client.

In one embodiment, the identifier is free of any communications means.

Although one embodiment contemplates the identifier free of any communication means, it is also contemplated that in one embodiment, the identifier includes, incorporated therewith, at least one means for providing location information.

In one embodiment, the client is located based on physical location data provided by said mobile computing device of said client.

In one embodiment, the method is further including the step of providing targeted commercial advertisements or announcements to said client.

In one embodiment, the method is further including the step of transmitting selected media files, including still photographs, video, and combinations thereof, to said client.

In one embodiment the present invention is a method for providing communications said method consisting essentially of the steps of:
registering a client with a database; providing said client with at least one identifier constructed and arranged to be worn by said client in a manner by which set identifier is readily visible by an observer, whereby said identifier is associated with at least one of a wristband, a pin, a keychain, a charm, and combinations thereof and said identifier is free of any communications means; providing said client a system mobile computing application operatively associated with a mobile computing device, whereby said mobile computing device is constructed and arranged to provide location information through said mobile computing application;
viewing said identifier by an authorized person with access to said database;
accessing a communications application on a mobile computing device by said authorized person; receiving location information of identifiers presents in a pre-defined distance from said mobile computing device of set authorized person, whereby said client is located based on physical location data provided by said mobile computing device of said client; and
transmitting a private message from set authorized person to said client.

### BREIF DESCRIPTION OF THE SEVERAL VIEWS OF THE DRAWINGS

FIG. 1 is demonstrative of a band and identifier incorporated thereon according to one embodiment of the present invention.

FIG. 2A is a closed band with identifier according to one embodiment of the present invention.

FIG. 2B is an open band with identifier there on according to one embodiment of the present invention.

FIG. 3A is a plan view of a plurality of connected bands according to one embodiment of the present invention.

FIG. 3B demonstrates a plurality of separated bands according to one embodiment of the present invention.

FIG. 4 is a flowchart of a process according to one embodiment of the present invention.

FIG. 5 is a continuation of the flowchart from figure according to one embodiment of the present invention.

FIG. 6 is a continuation of the flowchart from FIG. 5 according to one embodiment of the present invention.

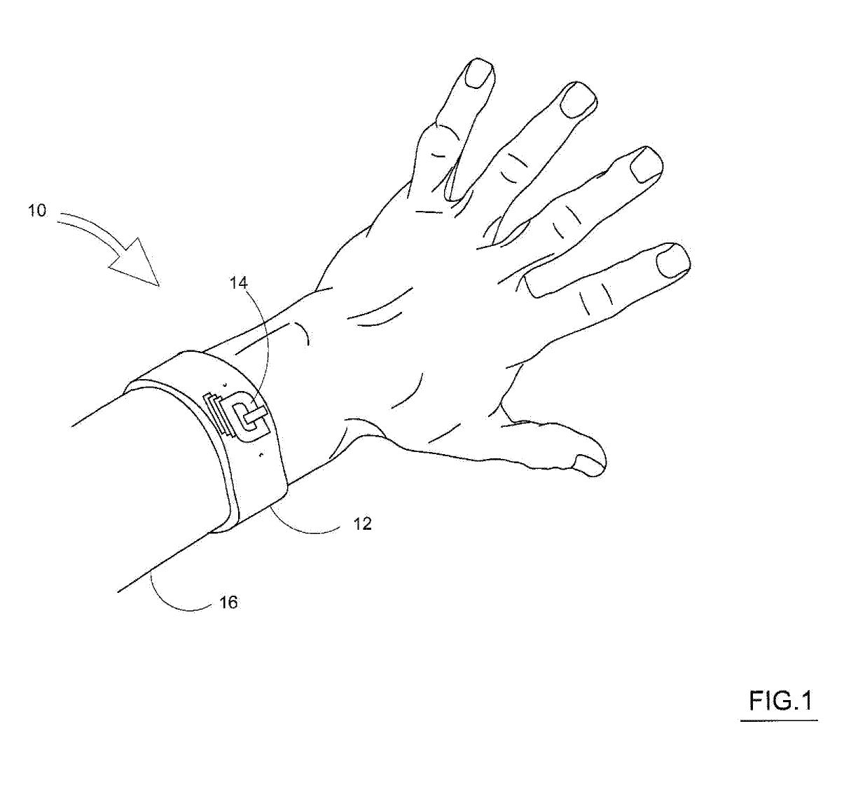

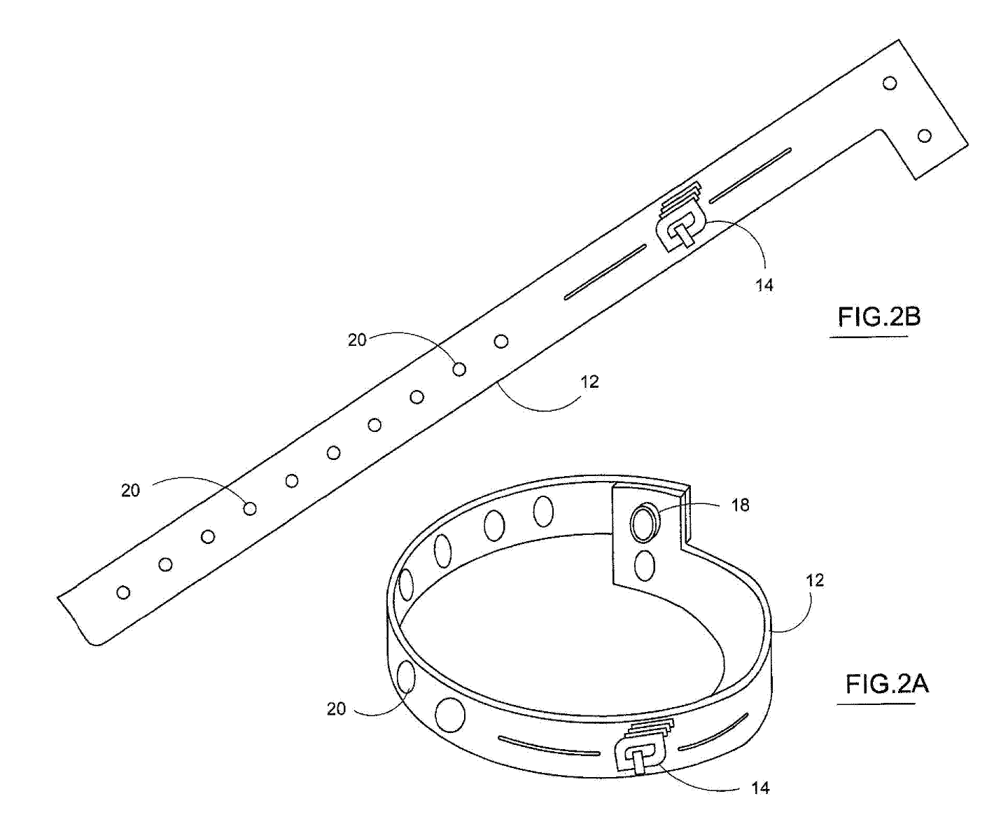

### DETAILED DESCRIPTION OF THE PREFERRED EMBODIMENT

The present invention includes a method for providing targeted social media business advertising. Although the embodiments in the figures demonstrate an identifier on a wristband, the present invention contemplates the readily visible display of an identifier carried or worn by a person. The identifier can be any one or more of articles with visual identifiers including but not limited to identify attached to a hat, identifier attached to a keychain or phone, identifier attached to a purse, identifier provided as a pin one on clothing, and other such means for the public and visual display identifying an individual as a member of the network according to the present invention.

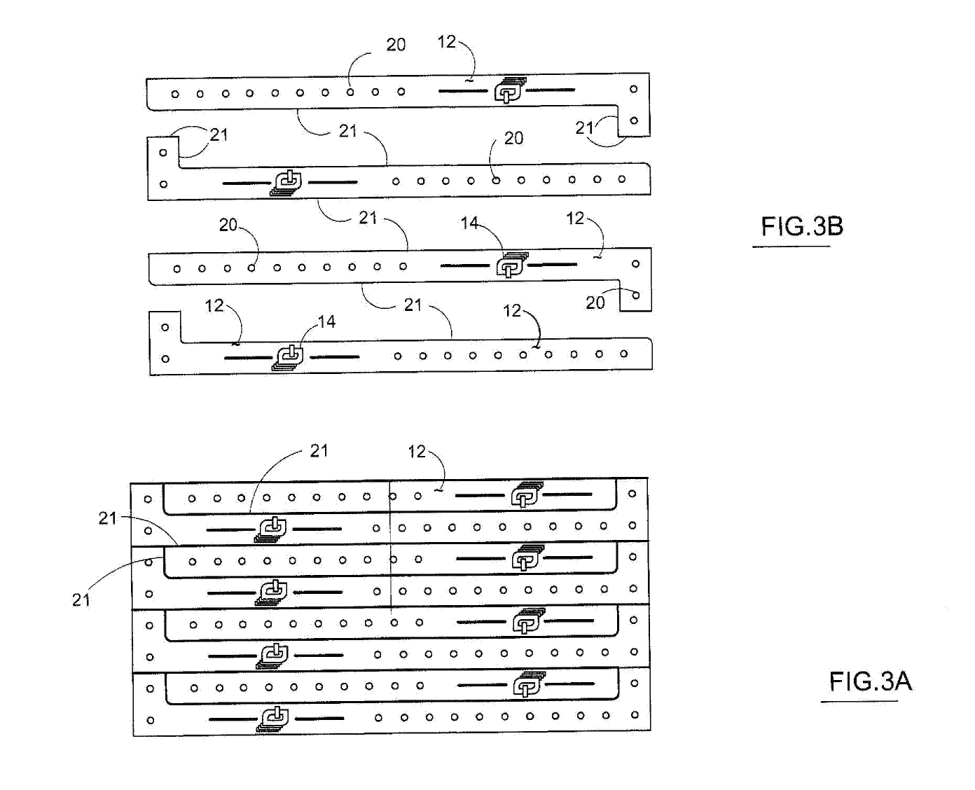

In one embodiment according to the present invention, a system 10 includes a wristband 12 warned by a client 16 and containing an identifier 14. In the specific embodiment where identifier 14 is provided on the spend 12 a plurality of wristbands can be provided as an attached sheet as in FIG. 3A whereby individualized wristbands are separated and distributed as in FIG. 3B wristband 12 includes a plurality of receiving openings 20 for receiving fastening post 18 there in. Further, each wristband 12 has a will limit her 21 that is identifiable once separated from a plurality sheet.

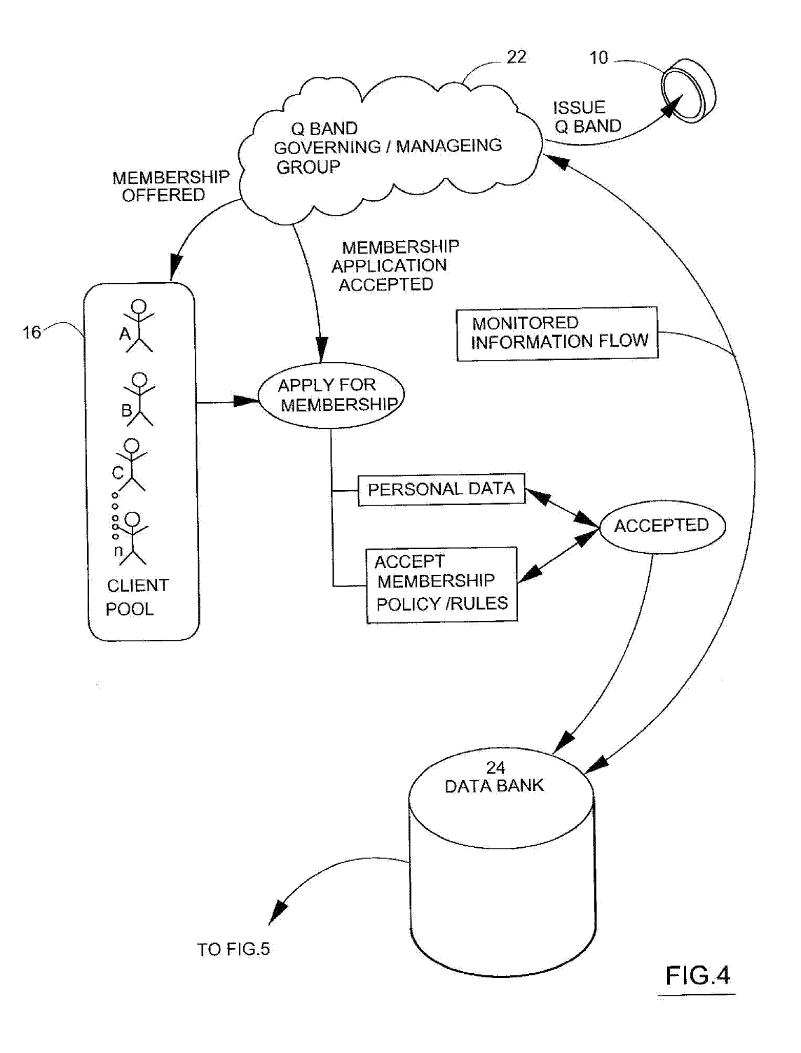

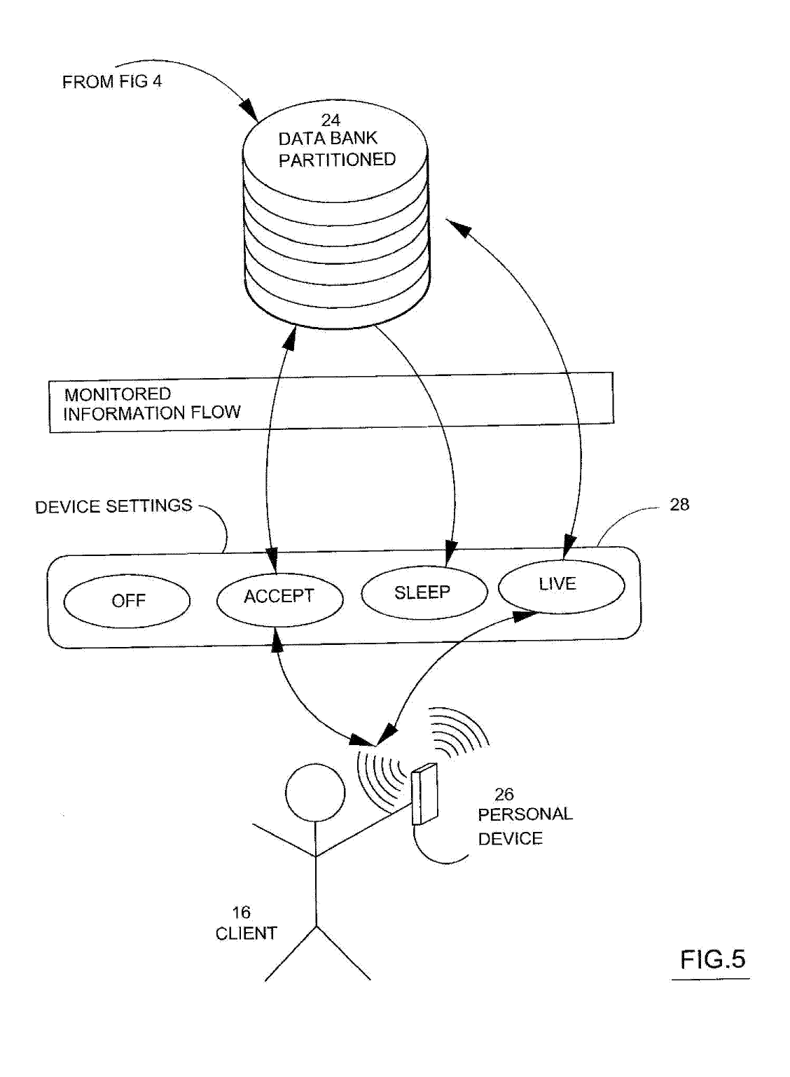

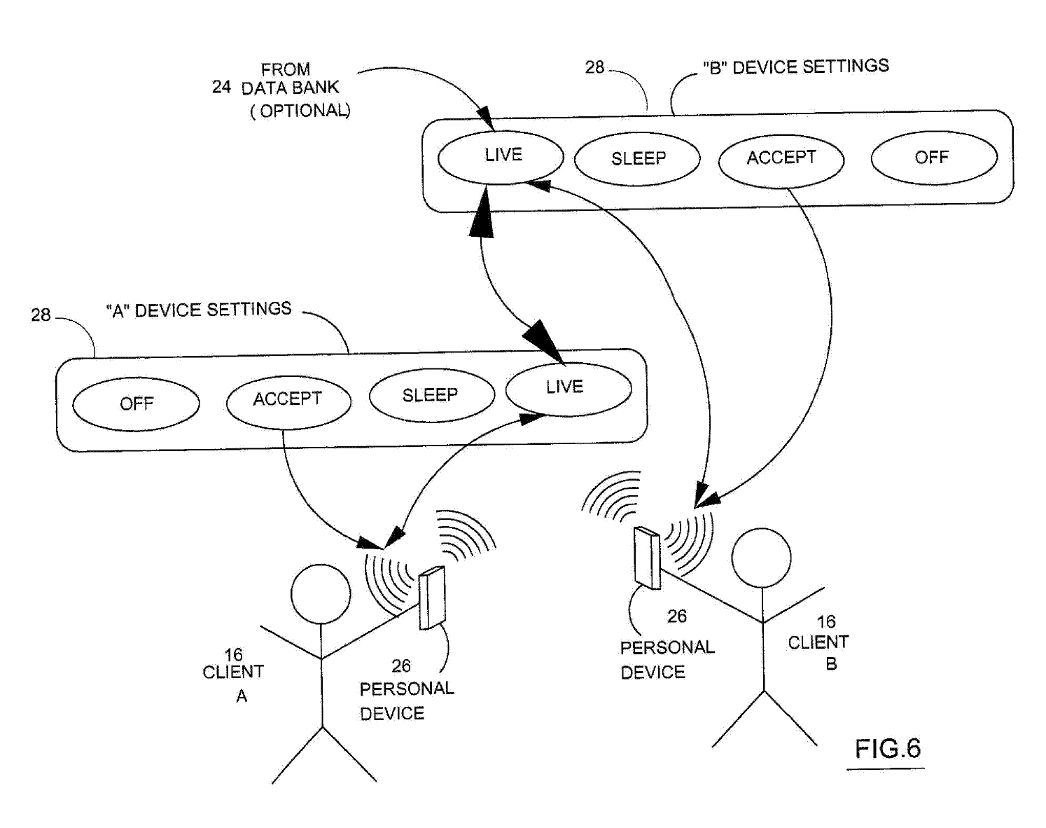

As demonstrated in the flowcharts of FIGS. 4 through 6, membership is monitored and governed by a managing group. Although the figure defines this as a managing group, this can be an individual, a group of persons, and organization, combinations thereof, and the like. An individual will provide a membership application and if accepted will be placed into client pool 16. In one embodiment, the client will provide personal data and except membership policies and rules as demonstrated in the figure. The quiet information will then be stored in databank 24. Each individual client will be given an identifier 14. The identifier 14, as stated above, is constructed and arranged to be a physical article that is readily one and observable by another person.

The client information in databank 24 in one embodiment, is partition. Information flow from client 16 children from databank 24 is monitored as desired.

In one embodiment, the method includes the steps comprising:
Registering a client; providing the client with an identifier; registering the client with the organization database; providing a communications application operatively associated with at least one of mobile computing device operated by the client;
publicly observing an identifier; a manager or authorized user activating a mobile computing device with a mobile computing application provided thereon and receiving geotag location and identifying information of identifiers present within a defined distance of the location of the mobile computing device; correlating registered identifiers to the geo-tag location; and providing a private message to a specific identified person wearing an identifier.

In this embodiment, the identifier need not include any type of communications means. The identifier 16 merely provides a visual indicator that the person displaying the identifier is part of the network. The person's identity is provided once a query is initiated and geotag positioning is established. Although the embodiment herein refers to geotag, any type of positioning technology is contemplated as being used according to the present invention. In one embodiment, a client 16 with personal mobile device 26 is provided with settings 28 whereby they can choose to be notified instantly or opt out of any type of notification.

In another embodiment according to the present invention identifier 16 has a communications means operatively associated therewith. The communications means provides for precise individualized communications in the method of the present invention as desired. The communications means can include but would not be limited to near field communications (NFC) chips, Bluetooth communications, and the like.

The following are nonlimiting examples of the present invention.

### EXAMPLE 1

Guest 1 Joe and Guest 2 Lisa are at a wedding. They both sign up to join the invitation only QBand network app paid for by the wedding host. They both receive a QBand or Qpin identifier. Joe spots Lisa at the wedding and sees the QBand identifier on her. Joe now knows that he can find out who Lisa is, whether she is single, what she does, interest, business needs, and who she knows, as well indicates what other networks she might be on. He simply comes closer to Lisa, and hits the “match now” button on his QBand app on his phone. Their profiles will pare up and Lisa's profile will appear with a compatible number. Joe can send Lisa a request to meet.

Without the QBand identifier, Joe would not know whether Lisa is on the network without going through the entire guest list of users, or having to keep checking whether she registered yet. He would not know how to find out who she is without asking someone else or actually talking with her.

If there was just an event app at the wedding, he would get a list of all the users, and to find her it takes too much time and effort. The person they are trying to find may or may not have signed up for the event app. The Qband clues them in.

### EXAMPLE 2

The next day Joe goes to the Nascar race. He registers his QBand for that event. The QBand event app is paid for by Nascar. He wants to find other fans to hang out with. He can enter in his search bar specific for things he wants to find in a male friend like age range, hobbies. The QBand identifier may not be needed for this type of use.

If Joe sees a guy at the event in front of him wearing a QBand, he may want to know who he is out of curiosity. He can press his “match now” on his app, and the guy's profile in front will appear. Joe may want to contact him because he sees he is a patent lawyer, and Joe just happened to have an idea he wants to discuss. He may want to talk to him right there, or message him later.

### EXAMPLE 3

Joe is waiting for a business meeting to happen a few days later at the Loew's Hotel in the lounge. He is wearing his QBand that he had received a few days eariler. Susan, the lady in the next booth, (also a QBand user), spots Joe and wants to know who Joe is. Susan presses the “match now” on the button and discovers that Joe is a recruiter. Lisa decides to contact Joe regarding a job and also she notices he is single. Perhaps a nice guy for her since she is single too.

Susan happens to notice the next profile under Joe's. This is a guy who happens to also be at the Loew's Hotel at an event upstairs. He is single and a doctor. She wants to meet him, so she sends him a message request.

### EXAMPLE 4

Joan is invited to the Children's Hospital charity event. When she arrives she is invited to join the QBand event app. Once she registers, Joan is given a QBand or QPin to wear. Now others know she is interested in networking for business or social and her profile is available online. Joan may be in the lady's room when Jill sees her, and wonders who she is. Jill sees Joan has a QBand on, so Jill presses her QBand app and selects “match now.” Within seconds Joan's profile appears on Jill's phone. She can decide to save and review for later, or send her a request now. QBand uses indoor geotagging on some models of the QBands where Bluetooth is required on their band or phone.

After the event, Joan decides to join the QBand open forum where other members from other events QBand has hosted have posted their profile. Joan wants to find other people associated with charity organizations, so she edits her search criteria to search for other people connected with charities. She can choose by location, or simply the closest matches found for her search.

The next day Joan goes to the Chamber of Commerce where they are hosting a QBand event. When she arrives, she is invited to join this networking group's app. Since her profile is already entered in the system, she simply logs in and enters the event code.

### EXAMPLE 5

Martin attends a cocktail party hosted by Bacardi Rum. He arrives and is invited to join the QBand network. He is given a QBand with an NCF chip included. After Martin registers his band and creates an account, others will know his profile is available for networking. People who see Martin's profile can save his profile for later or send him a message now. The QBand photographer will sync Martin's NCF chip to the QBand photographer's software which allows the photographer to scan Martin's QBand's NCF chip with a reader, and this sends each picture that is taken by the photograph where Martin is included straight to Martin's QBand app account. Martin can decide what pictures he wants to forward over to his social media. And Bacardi gets all their photos branded with the company logo uploaded to all of QBand user's social media, creating a great way for Bacardi to get its guests to remember and brand their event.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method for providing communications said method comprising the steps of:
registering a client with a database; providing said client with at least one identifier constructed and arranged to be worn by said client in a manner by which set identifier is readily visible by an observer; providing said client a system mobile computing application operatively associated with a mobile computing device, whereby said mobile computing device is constructed and arranged to provide location information through said mobile computing application;
viewing said identifier by an authorized person with access to said database;
accessing a communications application on a mobile computing device by said authorized person; receiving location information of identifiers presents in a pre-defined distance from said mobile computing device of set authorized person; and transmitting a private message from set authorized person to said client.

2. The method of claim 1 wherein said identifier is visual indicia worn by said client.

3. The method of claim 1 wherein said identifier is associated with at least one of a wristband, a pin, a keychain, a charm, and combinations thereof.

4. The method of claim 1 wherein said identifier is free of any communications means.

5. The method of claim 1 wherein said identifier includes, incorporated there with, at least one means for providing location information.

6. The method of claim 1 whereby said client is located based on physical location data provided by said mobile computing device of said client.

7. The method of claim 1 further including the step of providing targeted commercial advertisements or announcements to said client.

8. The method of claim 1 further including the step of transmitting selected media files, including still photographs, video, and combinations thereof, to said client.
